(19) United States
(12) Patent Application Publication
(10) Pub. No.: US 2010/0160551 A1
(43) Pub. Date: Jun. 24, 2010

(54) MINI-EMULSIONS AND LATEXES THEREFROM

(75) Inventors: James K. Marlow, Macedonia, OH (US); Paul M. Kayima, Strongsville, OH (US); Gamini S. Samaranayake, Broadview Heights, OH (US); Madhukar Rao, Twinsburg, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 12/644,176

(22) Filed: Dec. 22, 2009

Related U.S. Application Data
(60) Provisional application No. 61/139,702, filed on Dec. 22, 2008.

(51) Int. Cl. C08F 2/32; C08L 21/02

(52) U.S. Cl. 524/801

(57) ABSTRACT

A hybrid alkyd acrylic latex and a process for its preparation are taught. The process comprises forming an oil phase comprising an alkyd, a drier, and at least one ethylenically unsaturated monomer, wherein the oil phase solubilizes the drier; combining the oil phase with an aqueous phase, wherein the aqueous phase comprises a surfactant, to form a pre-emulsion; homogenizing the pre-emulsion thereby forming a miniemulsion, wherein the drier is solubilized in the oil phase; initiating the polymerization by adding a free radical initiator, thereby polymerizing the at least one ethylenically unsaturated monomer in the miniemulsion and forming a latex polymer emulsion having latex polymer particle sizes in the range of 40 nm to 700 nm.

### CROSS-REFERENCE TO RELATED APPLICATION

This application claims the benefit of U.S. provisional patent application No. 61/139,702 filed on Dec. 22, 2008.

This invention is directed to an alkyd/ethylenically unsaturated monomer miniemulsion and a process for making an alkyd/ethylenically unsaturated monomer miniemulsion in which a drier is solubilized in an oil phase. According to this invention, an oil phase comprising ethylenically unsaturated monomer(s), alkyd, and driers is dispersed in an aqueous phase under high shear conditions, forming a highly stable alkyd-monomer miniemulsion. The miniemulsion can then be polymerized under free radical polymerization, producing a highly stable alkyd latex.

Emulsion polymerization is a widely used technique for synthesizing latexes for water-based coatings. Conventional emulsion polymerization requires water, at least one monomer or mixtures thereof, a surfactant or mixture thereof, and a polymerization initiator. In a conventional latex emulsion process, the ethylenically unsaturated monomer or mixture thereof is typically blended and dispersed in water with surfactants under low shear to form a pre-emulsion and then polymerized via free radical polymerization to form a latex composition. Conventional emulsion polymerization starts with a monomer emulsion comprised of relatively large (in the range of 1 to 10 microns) monomer particles. The resulting polymer particles have an average particle size of less than one micron. Polymers commonly produced by emulsion polymerization are styrene-butadiene copolymers, acrylic polymers and copolymers, and polyvinyl acetate for water-based latex paints.

Clark et al., U.S. Pat. No. 6,333,378 (2001), describe a process of preparing water-based hybrid-latexes by miniemulsion polymerization of an alkyd and latent oxidatively functional acrylic monomers. A slight variation of this process, which does not restrict the claimed processes to latent oxidatively functional monomers, is disclosed by Schork et al., U.S. Pat. No. 6,369,135, (2002), which teaches a miniemulsion method of preparing graft copolymers of alkyd resins with various ethylenically unsaturated monomers (methyl methacrylate, styrene, etc.). The hybrid latex has been described as forming, on drying, polymeric films of good film properties and used as a replacement for latex paint binders in paint formulations.

Alkyd-latex polymeric binders produce films with good wear properties on oxidative curing that is mediated by metallic driers such as cobalt. Oil soluble metallic driers, such as cobalt octoate, that are post added are customary to alkyd technology.

According to this invention, a mini-emulsion is formed wherein ethylenically unsaturated monomer(s), an alkyd resin, and a metallic drier are first combined to form an oil phase, then blended with an aqueous phase comprising surfactant, and then homogenized together under high shear. After being subjected to high shear, the oil phase solubilizes the drier. While not intending to be bound by any theory, it is believed that the free radical polymerization of the miniemulsion forms hybrid latex polymer particles wherein the drier may become predominantly physically associated with the alkyd in the latex particle and the polymer formed from the ethylenically unsaturated monomers may substantially surround the alkyd, thereby forming highly stable latex particles that are resistant to hydrolysis.

The hybrid alkyd-acrylic latex composition of this invention have gloss and hydrolytic stability comparable to solvent-borne alkyds.

Another aspect of this invention is a process for producing a miniemulsion, such process comprises homogenizing under high shear an aqueous blend of an oil phase comprising one or more alkyd resins, at least one alkyd-drier and at least one ethylenically unsaturated monomer, wherein the drier becomes physically associated with the oil phase.

Another aspect of this invention is a process for polymerizing a miniemulsion, such process comprises the free radical polymerization of a miniemulsion comprising a mixture of alkyd and ethylenically unsaturated monomers, and wherein an alkyd drier is solubilized within the oil phase.

In yet another aspect of this invention is a latex or polymer emulsion that is the product obtained by a free radical polymerization of a miniemulsion comprising ethylenically unsaturated monomers, alkyd and drier. The latex particles of the miniemulsion polymerization have an average particle diameter in the range from about 40 to about 700 nanometers. Further still, this invention is a process for making a latex emulsion comprising latex particles comprising alkyd-solubilized driers.

These and other objects of this invention will be evident when viewed in light of the drawings, detailed description and appended claims.

### DETAILED DESCRIPTION OF THE INVENTION

In accordance with this invention, the term “miniemulsion” denotes an emulsion in which an oil phase comprising an alkyd, ethylenically unsaturated monomer(s) and at least one drier, when combined with an aqueous phase under high shear homogenization, forms a miniemulsion wherein the drier is solubilized in the oil phase. According to this invention, prior to homogenization, the aqueous phase comprises at least one surfactant. The miniemulsion particles have an average particle size of from about 40 nanometers to about 700 nanometers. A free radical initiator initiates the polymerization to form latex particles with alkyd-solubilized driers and with latex polymer formed from ethylenically unsaturated monomer(s), producing a hybrid alkyd-acrylic latex.

This invention is a process for the preparation of a latex emulsion, such process comprising:
(a) forming an oil phase comprising an alkyd, a drier, and at least one ethylenically unsaturated monomer, wherein the oil phase solubilizes the drier;
(b) combining the oil phase with an aqueous phase to form an alkyd-ethylenically unsaturated monomer-drier emulsion blend (hereinafter, a “pre-emulsion”), wherein the aqueous phase comprises a surfactant and a buffer;
(c) homogenizing the pre-emulsion under high shear, thereby forming a miniemulsion; and
(d) initiating polymerization by adding a free radical initiator, thereby polymerizing the at least one ethylenically unsaturated monomer in the miniemulsion and forming a latex polymer emulsion.

Alkyds useful for this invention include C12-C22 oil based alkyds with iodine value greater than 120; driers useful for this invention include metallic driers and other alkyd driers. The resulting latex polymer particles have average particle sizes in the range of 40 nanometers to 700 nanometers.

The latex emulsions of the present invention have improved hydrolytic stability and provide latex films having gloss and hardness comparable to solventborne alkyd films. While not intending to be bound by any theory, it is believed that due to the physical alkyd-drier affinity, the alkyd shields the drier from premature hydrolysis or deactivation in paint formulations.

### Oil Phase

The ethylenically unsaturated monomer(s) or mixture thereof (i.e., one or more monomers) can be monomers that are essentially insoluble in water and can be polymerized either alone or in monomer mixtures. Examples of suitable ethylenically unsaturated monomers include, but are not limited to, styrenic monomers such as styrene, alpha-methyl styrene, vinyl naphthalene, vinyl toluene, chloromethyl styrene and the like; ethylenically unsaturated species such as C1-C12 alkyl (meth)acrylates (for example, methyl acrylate, methyl methacrylate, ethyl acrylate, ethyl methacrylate, butyl acrylate, butyl methacrylate, isobutyl acrylate, isobutyl methacrylate, ethylhexyl acrylate, ethylhexyl methacrylate, octyl acrylate, octyl methacrylate), acrylic acid, methacrylic acid, styrene, glycidyl methacrylate, carbodiimide methacrylate, alkyl crotonates, vinyl acetate, di-n-butyl maleate, di-octylmaleate, and the like.

In general, alkyds useful in the oil phase according to this invention include water-insoluble alkyds. Long oils such as oleoresinous alkyds and medium oils, including C12-C22 oil-based alkyds, are typical examples of alkyds useful for this invention. Drying oils may also be used, including but are not limited to, coconut oil, fish oil, linseed oil, tung oil, castor oil, cottonseed oil, safflower oil, sunflower oil, soybean oil, and tall oil.

The function of the drier is to promote the oxidative polymerization of the unsaturated oils which are present in the coating composition to thereby form a solid film. Oxidation polymerization (i.e. drying) takes place after paint film application. Suitable driers for use in this invention include without limitation, metal-containing compounds; for example, cobalt, zirconium, manganese, calcium, zinc, copper, barium, vanadium, cerium, iron, potassium, strontium, aluminum, bismuth and lithium-containing compounds. Drier promoters can also be used for accelerating the curing or hardening of the film. Examples of non-metallic drier promoters include 8-hydroxyquinoline, quinoline, salicyl aldoxime, pyridine-2-carbaldoxime, acetylacetonate enamines, 2-2′-bipyridyl, ethylenediamine, propylenediamine, pyridine, o-vinylpyridine, o-aminopyridine, aniline, o-phenylenediamine, o-toluidine, alpha-naphthylamine, o-phenanthroline, dipropylamine, diamylamine, acrylonitrile, succinonitrile, o-tolunitrile, o-toluamide, pyrrole, benzimidazole, benzotriazole, benzophenone, benzophenone methacrylate, and the like. Driers and drier promoters can be present in the range of 0.05 weight percent to 0.50 weight percent, based on the total weight of the alkyd.

### Aqueous Phase

The aqueous phase is generally a water/surfactant/buffer mixture. The surfactant can be conventional surfactants used in emulsion polymerization. Either a single surfactant or a mixture of surfactants may be used. Representative surfactants include: sodium lauryl sulfate and other alkyl sulfates; sodium dodecyl benzene sulfonate and other alkyl and aryl sulfonates; sodium stearate and other fatty acid salts, alkylpolyethers and alkylpolyether sulfates; and polyvinyl alcohol and other non-ionic or polymeric surfactants. When a mixture of surfactants is used, the mixture may include an anionic or a cationic surfactant, plus a non-ionic surfactant, or two or more anionic or cationic surfactants, or two or more non-ionic surfactants. The amount of surfactant may be from about 0.5 to about 5.0 percent by weight, based on monomer plus alkyd resin. The preferred amount is from about 0.5 to about 2 percent by weight, based on monomer plus alkyd resin.

Additionally, polymeric or non-polymeric co-surfactants may be advantageously used in the aqueous phase. Polymeric co-surfactants that may be used include polymers that are both highly water insoluble and highly soluble in the monomer of choice. The polymeric co-surfactant may be a polymer (e.g., homopolymer, copolymer, or block or graft copolymer) or a mixture or blend thereof having a molecular weight in the range of about 3,000 to about 1,100,000, preferably from about 9,000 to about 750,000. Polymeric co-surfactants having a molecular weight in the range of about 350,000 to about 750,000 can also be used. Representative polymeric co-surfactants useable in the present invention include polymethyl methacrylate (PMMA), polystyrene, polyvinyl acetate, polymethylacrylate and polyethylacrylate. Certain copolymers such as styrene-isoprene copolymer, and certain block polymers such as poly (styrene-block-butadiene) and poly (styrene-block-isoprene) can also be useful. Other polymeric co-surfactants may be used as long as they meet the above criteria of being essentially insoluble in water but soluble in the monomer or monomer mixture, and are innocuous in the final product. The amount of polymeric co-surfactant can be from about 0.5 to about 5.0 percent by weight, based on the total weight of the monomer(s) and alkyd resin. In one embodiment, the polymeric co-surfactant is present at an amount of from about 0.5 to about 2 percent by weight, based on the total weight of the monomer(s) and alkyd resin.

Nonpolymeric co-surfactants may be used in place of polymeric co-surfactants, or in combination with them. Representative non-polymeric co-surfactants include hexadecane, cetyl alcohol, and highly water-insoluble monomers such as 2-ethyl hexyl methacrylate, iso-octylacrylate and isodecyl acrylate, and chain transfer agents such as dodecyl mercaptan. The amount of non-polymeric co-surfactant may be from about 0.5 to about 5.0 percent by weight, based on the total weight of the monomer(s) and alkyd resin. The amount of non-polymeric co-surfactant can be from about 0.5 to about 5.0 percent by weight, based on the total weight of the monomer(s) and alkyd resin. In one embodiment, the non-polymeric co-surfactant is present at an amount of from about 0.5 to about 2 percent by weight, based on the total weight of the monomer(s) and alkyd resin.

### Preparation of Miniemulsion

The relative ratio amount of the alkyd to the ethylenically unsaturated monomer(s) in the oil phase is approximately 40:60 to about 60:40. A drier is present at about 0.02% by weight to 0.5% by weight, based on the total monomer and alkyd weight. The aqueous phase is blended with the oil phase to form a pre-emulsion. The pre-emulsion is then subjected to high shear homogenization utilizing, for example a microfluidizer, sonicator, homogenizer, colloid mill or other device, until the alkyd and monomer particle sizes are in the range of about 40 nanometers to about 700 nanometers. During the process of high shear homogenization, the drier becomes solubilized in the oil phase.

### Preparation of Latex Emulsion

The latex polymers of this invention are prepared by free radical polymerization of the miniemulsion blend. While the temperature in this step is not critical (in general, any temperature between the freezing point and the boiling point of the reaction components can be used), temperatures for conventional free radical emulsion polymerization range from about 20° C. to about 90° C. Polymerization temperature can also depend on the choice of the free radical initiator. The particles of the miniemulsion have average particle size in the range of 40 nm to 700 nm. The monomer content of the miniemulsion is polymerized under free radical polymerization conditions in the presence of a free radical initiator. Both the initiator and the conditions may be conventional. Suitable free radical initiators are known in the art. These include, for example, the organic peroxides such as benzoyl peroxide, lauroyl peroxide and dicumyl peroxide; hydroperoxides such as tertiary butyl hydroperoxide, toluoyl hydroperoxide, cumene hydroperoxide, amyl hydroperoxide; and inorganic persulfates such as potassium persulfate or ammonium persulfate; azobis-(isobutyro nitrile) (AIBN). The type of initiator is not critical to this invention. The polymerization initiator may be either a water-soluble or an oil soluble compound.

The latex polymer average particle size is in the range from about 10 to about 1,000 nanometers. In one embodiment, the latex polymer average particle size in the latex emulsion is in the range of about 40 nm to about 700 nanometers. In another embodiment, the latex polymer average particle size range is from about 80 to about 400 nanometers.

### Resin Compositions

Polymer latexes produced according to the present invention can be used to formulate water-borne coatings. The coatings will have environmental (low in volatile organic compounds) and convenience (water cleanup) advantages of latex coatings, as well as the crosslinking, hydrolytic stability and gloss-development benefits from the alkyd. This invention will now be described in further detail with reference to the examples that follow.

### Latex Example 1

A miniemulsion can be prepared from the formulation shown in Table 1, using the following procedure. Glycidyl methacrylate, dimethyl benzylamine (catalyst) and methylhydroquinone are blended together with alkyd and heated to 120 C, and held for 2 hours. The monomers and driers can be blended together and added with the alkyd. Water, surfactant(s) and buffers are premixed and then added to the monomer/alkyd/drier mix to form the pre-emulsion. The pre-emulsion is subjected to high shear using a microfluidizer (Model # M-110Y, Microfluidics Corp, Mass, USA) at 1200-1300 psi, two cycles each lasting for about 12-15 min or repeating until particle size is less than 400 nm to form a miniemulsion. The miniemulsion is poured into the reactor and then the initiator is fed over 4 hours and then held for 30 minutes. The chase comprising of too separate feeds of t-butylhydroperoxide and ascorbic acid is fed over 2 hours and held for 1 hour. The reaction mix is cooled and the pH is adjustered to 8.5, and the percent NVM is measured. Particle sizes are measured by a laser light scattering instrument (Malvern, Mass., USA). The average particle size ranges from between 40 nm to 700 nm.

TABLE 1

| Raw Material | Weight Percent |
|---|---|
| Polystep B-23 | 1.50 |
| Rhodasurf LA-12 | 0.26 |
| SPS | 0.48 |
| Polyethylene Terephthalate Alkyd | 62.27 |
| Butyl acrylate | 16.29 |
| Methyl methacrylate | 16.29 |
| Glycidyl methacrylate | 0.54 |
| Methacrylic acid | 0.38 |
| Stryrene | 4.23 |
| Dimethylbenzyl amine | 0.01 |
| 12% cobalt octoate | 0.08 |
| DryRX | 0.02 |
| MEHQ | 22 ppm |
| t-Butylhydroperoxide | 0.09 |
| Ascorbic acid | 0.19 |
| PS nm | 255 |
| NVM % | 52.6 |

SPS = sodium persulfate; Surfactants: Polystep, Rhodasurf; MEHQ = methylhydroquinone; PS = particle size, NVM = non-volatile mass

### Paint Examples

Comparative results of latex paint samples utilizing the miniemulsion of this invention (Example 1 above) vs. latex samples from conventional emulsion polymerization are provided in Table II. Coated substrates are made using the latex products of the miniemulsions. Draw downs of 4 mil wet film thickness are prepared and dried at room temperature. The results are given in Table II.

TABLE II

| | Drying | | | | |
|---|---|---|---|---|---|
| Sample | DT | TF | DH | Gloss | Stability |
| SWP Alkyd control | 2.75 hr | 6 hr | 9 hr | 79 | 7 |
| Control latex | 20 min | 30 min | 1 hr | 70 | 8 |
| Example 1 | 45 min | 1 hr | 5 hr | 80 | 10 |

DT = dry to touch;
TF = Tack-Free;
DH = Dry hard;
SWP = Sherwin-Williams solvent-borne alkyd.

The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. While this invention has been described in detail with reference to preferred embodiments, it shall be understood that such description is by way of illustration and not by way of limitation.

We claim:

1. A process for the preparation of a latex composition comprising:
a. forming an oil phase comprising an alkyd, a drier, and at least one ethylenically unsaturated monomer, wherein the oil phase solubilizes the drier;
b. combining the oil phase with an aqueous phase, wherein the aqueous phase comprises a surfactant, to form a pre-emulsion;
c. homogenizing the pre-emulsion thereby forming a miniemulsion, wherein the drier is solubilized in the oil phase;
d. initiating the polymerization by adding a free radical initiator, thereby polymerizing the at least one ethylenically unsaturated monomer in the miniemulsion and forming a latex polymer emulsion having latex polymer particle sizes in the range of 40 nm to 700 nm.

2. The process of claim 1, wherein the drier is a metallic drier.

3. The process of claim 1, wherein the drier is selected from the group consisting of cobalt, zirconium, manganese, calcium, zinc, copper, barium, vanadium, cerium, iron, potassium, strontium, aluminum, bismuth and lithium compounds.

4. The process of claim 1, wherein the alkyd is a C12-C22 oil-based alkyd having an iodine value greater than 120.

5. The process of claim 1, wherein the alkyd is selected from the group consisting of vegetable oil, C12-C22 oil-based alkyds, coconut oil, fish oil, linseed oil, tung oil, castor oil, cottonseed oil, safflower oil, sunflower oil, soybean oil, and tall oil, and

6. The process of claim 1, wherein the drier is present in the oil phase in the range of 0.05 weight percent to 0.50 weight percent, based on the total weight of the alkyd.

7. The process of claim 1, wherein the alkyd has an iodine level greater than 120.

8. The process of claim 1, wherein the ratio of the alkyd to the total monomer present in the oil phase is 40:60 to 60:40.

9. The process of claim 1 wherein the surfactant is a surfactant selected from the group consisting of cationic, anionic, nonionic or polymeric surfactant, or a mixture thereof.

9. The process of claim 1 wherein the amount of surfactant is from about 0.5 to 5.0 percent by weight based on the total weight of the monomer and alkyd.

10. The process of claim 1 wherein the ethylenically unsaturated monomer is selected from the group consisting of vinyl monomers, acrylic monomers, allylic monomers, acrylamides, acrylonitriles N-vinyl amides, N-allyl amines mono- and dicarboxylic unsaturated acids and vinyl ethers. Vinyl esters may be used and may include vinyl acetate, vinyl propionate, vinyl butyrates, vinyl neodeconate and similar vinyl esters; vinyl halides include vinyl chloride, vinyl fluoride and vinylidene chloride; vinyl aromatic hydrocarbons include styrene, a-methyl styrene, and similar lower alkyl styrenes. Acrylic monomers include monomers such as alkyl esters of acrylic or methacrylic acid having an alkyl portion containing between 1 to 12 carbon atoms as well as aromatic derivatives of acrylic and methacrylic acid. Useful acrylic monomers may include, for example, acrylic and methacrylic acid esters of aliphatic alcohol having C₁ to C₁₂: methyl acrylate, and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl and dodecyl acrylate and methacrylate, isodecylacrylate and methacrylate, and benzyl acrylate and methacrylate; poly(propylene glycol) acrylates and methacrylates, poly(ethylene glycol) acrylates and methacrylates and their ethers of alcohols containing from 1 to 18 carbon atoms.

11. A product of the process of claim 1.

12. The product of claim 11, wherein the volatile organic content is less than 50 grams/liter.

13. A process for the preparation of a mini-emulsion comprising:
a. forming an oil phase comprising an alkyd, a drier, and at least one ethylenically unsaturated monomer, wherein the oil phase solubilizes the drier;
b. combining the oil phase with an aqueous phase, wherein the aqueous phase comprises a surfactant to form a pre-emulsion;
c. homogenizing the pre-emulsion at high shear thereby forming a miniemulsion, wherein the drier is solubilized in the oil phase; and wherein the average particle size of the monomer particles and the alkyd is in the range of 40 nanometers to 700 nanometers.

14. A latex pre-emulsion, said pre-emulsion comprising:
a. an oil phase comprising an alkyd, a drier, and at least one ethylenically unsaturated monomer, wherein the drier is dissolved in the oil phase;
b. an aqueous phase, wherein the aqueous phase comprises a surfactant; and wherein the oil phase and aqueous phase are blended at high shear to form average particle sizes in the range of 40 nm to 700 nm.

15. A latex polymer particle, comprising;
a drier associated with an alkyd in the latex polymer particle, said latex polymer particle formed from a free radical polymerization of a latex pre-emulsion comprising:
a. an oil phase comprising an alkyd, a drier, and at least one ethylenically unsaturated monomer, wherein the drier is dissolved in the oil phase;
b. an aqueous phase, wherein the aqueous phase comprises a surfactant; and
c. wherein the oil phase and aqueous phase are blended at high shear to form average particle sizes in the range of 40 nm to 700 nm.
